(19) United States
(12) Patent Application Publication
(10) Pub. No.: US 2026/0200716 A1
(43) Pub. Date: Jul. 16, 2026

(54) METHOD AND APPARATUS FOR MONITORING A LIQUID LOADING PROCESS

(71) Applicant: BASF SE, Ludwigshafen am Rhein (DE)

(72) Inventors: Frank HUETTEN, Ludwigshafen am Rhein (DE); Sebastian Tobias UPPENKAMP, Ludwigshafen am Rhein (DE); Moritz Robert SCHNEIDER, Ludwigshafen am Rhein (DE)

(21) Appl. No.: 19/136,323

(22) PCT Filed: Nov. 28, 2023
(86) PCT No.: PCT/EP2023/083271

§ 371 Date: Jun. 6, 2025

(30) Foreign Application Priority Data
Dec. 8, 2022 (EP) 22212121.2

(51) Int. Cl. B67C 3/00; G01N 9/32

(52) U.S. Cl. CPC B67C 3/007; G01N 9/32

(57) ABSTRACT

The invention relates to a method and an apparatus for monitoring a loading process, in which a liquid is transported from a starting container through a pipeline into a target container, wherein the method is carried out in a data processing device, comprising the following steps:
(a) reading measured values of the density, the pressure, and/or the temperature of the liquid transported in the pipeline from at least one measuring device,
(b) determining an acceptable range of the density of the liquid transported in the pipeline,
(c) comparing the density measured value to the acceptable range, wherein the density measured value and/or the acceptable range are adapted if necessary as a function of the pressure and/or temperature measured values, so that they are comparable, and
(d) outputting a signal if the density measured value is outside the acceptable range.

The invention relates to a method and an apparatus for monitoring a loading process, in which a liquid is transported from a starting container through a pipeline into a target container, wherein the method is carried out in a data processing device.

Loading processes, in which liquid products are conducted from a starting container through a pipeline into a target container, are established technology in diverse branches of industry. Such loading processes are often monitored by measuring devices in order to ensure the proper course of the loading process and identify possible disturbances early. One possible disturbance is the occurrence of a gas phase in a pipeline, for example, due to evaporation of a part of the liquid in the pipeline or due to the aspiration of a gas phase from the starting container when its fill level is too low. Measures for monitoring are known from the prior art for detecting a gas phase or multiphase flow in a transport line.

A filling system is described in document WO 02/060805 A2, which is suitable, for example, for loading liquefied petroleum gas (LPG). The density of the product flowing through a pipeline is continuously determined by means of a Coriolis mass flow rate measurement. As soon as a strong deviation in the density is recognized, from which the occurrence of a multiphase flow can be concluded, the loading is stopped.

An apparatus is known from document WO 2021/018978 A1, by means of which liquid pharmaceuticals are filled in packaging containers. It is also ensured therein via a density measurement that only liquid product without gas components enters the packaging.

In addition to the problem of potential multiphase flows, however, there are still further possible disturbances in loading processes of liquid products which are conducted from a starting container through a pipeline into a target container. It can thus occur, for example, that a product other than that intended flows through the pipeline to the target container, for example, due to an incorrect operation by the operating personnel or due to a technical malfunction. If such a mistake has occurred, the already filled product often has to be discarded and disposed of. In addition to the economic damage, however, there is also the risk that a hazardous state will occur in the target container, for example, if the product is a chemical which enters an unsuitable target container or is mixed with another chemical, with which it can react.

The object presented itself of improving known loading procedures such that reliable product control is enabled, which is universally usable for greatly varying liquid substances.

This object is achieved according to the invention by a method according to claim 1 and an apparatus according to claim 7. Advantageous designs of the method are specified in claims 2 to 6.

The method according to the invention for monitoring a loading process, in which a liquid is transported from a starting container through a pipeline into a target container, is performed in a data processing device and comprises the following steps:
(a) reading measured values of the density and either the pressure or the temperature or the pressure and the temperature of the liquid transported in the pipeline from at least one measuring device,
(b) determining an acceptable range of the density of the liquid transported in the pipeline by
(b1) reading an acceptable range of the density or
(b2) calculating an acceptable range of the density on the basis of the read measured values of pressure and/or temperature,
(c) comparing the density measured value to the acceptable range, wherein the density measured value and/or the acceptable range are adapted if necessary as a function of the pressure and/or temperature measured values, so that they are comparable, and
(d) outputting a signal if the density measured value is outside the acceptable range.

The apparatus according to the invention for monitoring a loading process, in which a liquid is transported from a starting container through a pipeline into a target container, comprises a data processing device, which includes:
means for reading measured values of the density and either the pressure or the temperature or the pressure and the temperature of the liquid transported in the pipeline from at least one measuring device,
means for determining an acceptable range of the density of the liquid transported in the pipeline, the means for determining comprising means for reading an acceptable range of the density from an input unit and/or means for calculating an acceptable range of the density on the basis of the pressure and/or temperature measured values,
means for comparing the density measured value to the acceptable range, which are configured so that the density measured value and/or the acceptable range are adaptable as a function of the pressure and/or temperature measured values, and
means for outputting a signal if the density measured value is outside the acceptable range.

A further subject matter of the invention is a computer program having program code which, when the computer program is executed on a suitable computer system, carries out the method according to the invention.

A further subject matter of the invention is a computer program product having a computer-readable medium and a computer program, stored on the computer-readable medium, having program code means which, when the computer program is run on a suitable computer system, carry out the method according to the invention.

It has been shown that, using the method according to the invention and the apparatus according to the invention, the products intended for loading can be reliably identified on the basis of their density before entering a target container and reliable monitoring of the loading process is possible on this basis. A further advantage of the method according to the invention is the possibility of cost-effective implementation in an apparatus according to the invention, which does not require complex measures, but rather uses components, such as sensors, often present in loading processes in a skilled manner.

The method and the apparatus are suitable for monitoring a variety of loading processes. The liquids to be loaded can be safe substances such as water or food. However, they can also be hazardous materials, such as crude oil, oil fractions, gasoline, kerosene, or liquid chemicals of greatly varying types. Starting container, pipeline, and target container can be non-temperature-controlled or temperature-controlled, for example, cooled or heated. The containers can be tanks installed fixed in place. These can also be movable tanks and containers such as tank cars, tank containers, tank trucks, or ships.

The same container can also be a starting container or a target container depending on the loading process, depending on whether the loading process involves filling or emptying. In one embodiment, the loading process takes place between a fixed tank and a movable tank, for example, a tank container. In the loading process “filling”, the fixed tank is the starting container and the movable tank is the target container. In the reverse loading process “emptying”, the movable tank is the starting container and the fixed tank is the target container.

The pipeline, through which the liquid is transported, can be permanently connected to the starting container, the target container, or both. It can also be detachably connected to one or both of the containers. In one embodiment, in which the loading process takes place between a fixed tank and a movable tank, the pipeline is preferably permanently connected to the fixed tank and is detachably connected to the movable tank. The detachable connection can be, for example, a so-called hose nozzle for connecting a fixed line to a filler tube or drain tube of a movable tank.

The method according to the invention is carried out in a data processing device, the apparatus according to the invention comprises such a data processing device. The steps of the method and the means of the data processing device can be implemented as software components, hardware components, or combinations of hardware and software components. The data processing device can be present locally at the location of the loading process, for example, as a standalone application at a filling station. The data processing device can also be part of a more extensive automation system, for example, as a building block of a programmable logic controller (PLC) or a process control system (PCS). The data processing device can be implemented as a central system or as a decentralized system distributed onto multiple components which exchange data with one another.

In the first step of the method, measured values of the density of the liquid transported in the pipeline are input from at least one measuring device. Furthermore, measured values of the pressure, the temperature, or the pressure and the temperature of the liquid transported in the pipeline are input from at least one measuring device. The inputting takes place via means for inputting measured values. The measured values of the density, the pressure, and the temperature can be input from a single measuring device which is capable of detecting all three measured values. The measured values can also be input from different measuring devices, for example, the density from a density measuring device, the pressure from a pressure measuring device, and the temperature from a temperature measuring device. Corresponding measuring devices are known in the prior art. In one embodiment, the metrological determination of the density takes place in a flow meter, preferably in a Coriolis flow meter.

Means for inputting measured values can comprise all communication means via which data signals can be transmitted from a measuring device to the data processing device. These can be wired communication means, wireless communication means, or combinations thereof. The selection of the respective means is guided by the requirements of the application. In the case of a use in the sector of chemical process technology, it is thus to be ensured, for example, that no hazard originates from the communication means, for example, in areas subject to explosion hazards.

In the second step of the method, an acceptable range of the density of the liquid transported in the pipeline is determined. The determination can take place in various ways. In a first variant, an acceptable range of the density of the liquid transported in the pipeline is input. The acceptable range can be a single value or a value range here. The inputting takes place via means for inputting. In one embodiment, the means for inputting comprise input means, via which an operator can input a value or a value range, for example, a keyboard, an operating panel, a writable display, or a microphone for inputting speech commands. The inputting of the acceptable range can also take place in that the acceptable range is provided in another application and is transmitted via a communication interface to the data processing device, for example, in applications in which the data processing device is part of a more extensive automation system.

In one embodiment, in the first variant of the second step (b1) of the method according to the invention, initially an identification feature for the liquid transported through the pipeline is input from an input unit and then the acceptable range for the density is read out from a product database on the basis of the identification feature.

The identification feature can be, for example, a name or another identifying designation of the product to be loaded. It can be read via means for reading. The reading process of the identification feature can also take place in that a selection of identification features is provided, for example, as a list, and an operator selects an identification feature from the selection.

The product database, from which the acceptable range can be read out on the basis of the identification feature, can be part of the data processing device or a separate database, which is connected via a communication interface to the data processing device.

In a second variant for determining an acceptable range of the density of the liquid transported in the pipeline, an acceptable range of the density is calculated on the basis of the measured values, which are read in the first step (a), of pressure, temperature, or pressure and temperature. The calculation takes place via means for calculating. The means for calculating can be a computing unit of a computer, in which computing operations and comparing operations can be carried out.

The acceptable range can be calculated, for example, in that initially on the basis of the measured values, a reference value for the density to be expected at the measured values of pressure and/or temperature is calculated. The calculation of the reference value of the density can be carried out, for example, by a computing operation of the following formula:

$$ρ = \frac{a}{{b}^{1 + {( 1 - \frac{T}{c} )}^{d}}}$$

Therein, p designates the calculated reference value of the density, T designates the temperature read in the first step, and a, b, c, d designate material-specific parameters of the liquid.

The calculation of the reference value of the density can also be carried out, for example, by a computing operation of the following formula:

$$( p + a \cdot {ρ}^{2} ) \cdot ( ρ - b ) = R \cdot T$$

Therein, p designates the calculated reference value of the density, p designates the pressure read in the first step, T designates the temperature read in the first step, a, b designate material-specific parameters of the liquid, and R designates the universal gas constant.

The material-specific parameters can be provided in different ways. Similarly as in the reading of an acceptable range, the material-specific parameters can be provided to the data processing device via means for reading. The parameters can be input, for example, by an operator, e.g., via a keyboard, an operating panel, a writable display, or a microphone for inputting speech commands. The parameters can also be provided from another application and can be transmitted via a communication interface to the data processing device, for example, in applications in which the data processing device is part of a more extensive automation system. Similarly as in the reading of an acceptable range, the material-specific parameters can also be read out from a product database by means of an identification feature for the liquid transported through the pipeline, which is read from an input unit.

In order to reach the acceptable range from the reference value, for example, a predetermined value can be subtracted from the reference value in order to obtain the minimum value of the acceptable range, and a predetermined value can be added to the reference value in order to obtain the maximum value of the acceptable range. The subtracted value and the added value can be identical or different in absolute value. Preferably, the two values are identical, so that a symmetrical confidence interval of the acceptable range around the reference value results. The subtracted value can be an absolute value, a percentage value, or a combination of an absolute value and a percentage value. Likewise, the added value can be an absolute value, a percentage value, or combination of an absolute value and a percentage value. In a percentage value, the percentage can relate, for example, to the calculated reference value.

In the third step of the method, the density measured value is compared to the acceptable range. The comparison takes place via means for comparing. The means for comparing can be a computing unit of a computer, in which computing operations and comparing operations can be carried out.

In the comparison, it is to be ensured that the read measured value for the density and the read acceptable range are comparable. One aspect of the comparability relates to the physical unit of the density and its scaling. A corresponding conversion is possible via known formulas and can be carried out by the means for comparing in the data processing device. A further aspect of the comparability relates to the dependence of the density on other physical factors such as pressure and temperature. In cases in which the read values of the pressure and the temperature of the liquid transported in the pipeline correspond to the values for which the acceptable range was read, no adaptation measures are necessary, and the read density measured value can be compared directly to the acceptable range. In cases in which the acceptable range of the density relates to values of pressure and/or temperature other than the read measured values, it is necessary for the density measured value and/or the acceptable range to be adapted as a function of the pressure and temperature measured values, so that they are comparable. An adaptation is required, for example, if the values of the acceptable range relate to normal conditions, for example, atmospheric pressure and a temperature of 20° C., but the read measured values deviate from the normal conditions.

An adaptation can be carried out, for example, by a computing operation of the following formula:

$$ρ = \frac{a}{{b}^{1 + {( 1 - \frac{T}{c} )}^{d}}}$$

Therein, ρ designates the density, T designates the temperature, and a, b, c, d designate material-specific parameters of the liquid.

An adaptation can also be carried out, for example, by a computing operation of the following formula:

$$( p + a \cdot {ρ}^{2} ) \cdot ( ρ - b ) = R \cdot T$$

Therein, ρ designates the density, p designates the pressure, T designates the temperature, a, b designate material-specific parameters of the liquid, and R designates the universal gas constant.

In one embodiment, in step (b1) of the method, reference values for pressure and temperature assigned to the acceptable range are read, and in step (c), the adaptation of the density measured value and/or the acceptable range takes place on the basis of the pressure and temperature reference values and the pressure and/or temperature measured values. The reading of the reference values can take place analogously to the reading of the acceptable range. The reference values can be read from a database like the acceptable range on the basis of an identification feature. This can be the same database from which the acceptable range is read. However, it can also be a separate database, which is connected via a communication interface to the product database and/or other components of the data processing device.

In the fourth step of the method, a signal is output if the density measured value is outside the acceptable range. The output takes place via means for outputting the signal. As soon as the density measured value is outside the acceptable range, a status of the loading process is given which should be reacted to in some way, since it does not correspond to the desired or predetermined status. The reaction can be carried out here by an operator, an automatic mechanism, or both.

In one embodiment, the outputting of the signal causes an optically and/or acoustically perceptible display for an operator of the loading process. The operator is thus made capable of reacting immediately to the detected departure from the acceptable range. Examples of means for optically and/or acoustically perceptible display are light indicators on operating devices, warning lights, flashing indicators on displays, sound signals, and combinations thereof. The output can expediently take place where an operator stays during the loading process. If it is provided, for example, that the operator stays in the vicinity of a movable tank as the starting container or target container during the loading process, the output of the signal preferably takes place in the visual range and/or hearing range of the operator in the surroundings of the movable tank. The output can comprise, for example, a warning light and/or warning siren, which is attached in the vicinity of the pipeline, from which the movable tank is filled or emptied.

In contrast, if it is provided that the operator stays during the loading process in a room, for example, a control room or an office, the means for outputting the signal can preferably comprise indicators on an operating display or optical and/or acoustic output apparatuses in the relevant room.

The means for outputting the signal can also comprise applications on mobile devices such as smartphones, tablets, or wearables which an operator carries. In this case, the means additionally comprise communication interfaces, via which the data processing device can communicate with the mobile devices.

In one embodiment, the signal in step (d) of the method comprises a positioning signal, which is output to a shutoff fitting, by which the shutoff fitting is prompted to shut off the pipeline, so that the transport of the liquid is stopped. The means for outputting the signal can in this embodiment comprise known signal transmission means such as wired transmission means or wireless transmission means as well as communication interfaces between the data processing device and the shutoff fitting. The shutoff fitting can be, for example, a ball valve or a valve. The shutoff fitting can be arranged in the vicinity of the starting container, in the vicinity of the target container, or at another point of the pipeline. This embodiment can also comprise multiple shutoff fittings, for example, a first shutoff fitting in the vicinity of the starting container and a second shutoff fitting in the vicinity of the target container, so that immediately after recognition of the departure from the acceptable range, the liquid can be enclosed in the pipeline and can flow neither into the starting container nor into the target container.

Embodiments in which an operator is optically and/or acoustically informed can also be combined with embodiments in which the pipeline is automatically shut off. Thus, for example, simultaneously with the shutoff of one or more shutoff fittings, an optical signal on a display for an operator or a warning tone can be output.

Steps (a) to (d) of the method according to the invention can follow one another sequentially or can be partially carried out in parallel to one another. For example, the reading of measured values according to step (a) can take place in parallel to the reading of an acceptable range of the density according to step (b1). Step (b1) can also take place before step (a). In the case of steps which are dependent on the completed performance of other steps, the step sequence results from the logical order.

### EXAMPLE

In a production operation of the chemical industry, in which different variants of a product are produced, the produced products were stored in multiple product tanks, from which they were filled into tank cars sequentially via a pipeline. The product tanks were connected to a common pipeline and could be connected or disconnected via separate positioning valves. A Coriolis mass flow meter was arranged in the pipeline, which, in addition to the mass flow rate, also provided the density of the liquid flowing through as a measured value. The pressure and the temperature of the liquid flowing in the pipeline were detected via separate sensors in the pipeline. A further control valve, by means of which the pipeline could be shut off completely, was located in the pipeline before the outlet for the tank cars.

The control valves, meters, and sensors were connected via wired data lines to a data processing device, which was integrated in a process control system (PCS). The process control system comprised a display having input devices for operation by an operator. To start the loading process, it was provided that the operator selects the product to be loaded from a list of products on the display. On the basis of this selection, the data processing device caused material-specific parameters of the selected product to be read out from a product database, which was connected for communication to the data processing device, into the data processing device.

After the start of the loading process, measured values of the density, the pressure, and the temperature of the liquid flowing through the pipeline were continuously detected and transmitted to the data processing device. The read measured value for the temperature was used to calculate an acceptable range of the density. To calculate the acceptable range, initially a reference value of the density to be expected at the measured temperature was calculated according to the following formula:

$$ρ = \frac{a}{{b}^{1 + {( 1 - \frac{T}{c} )}^{d}}}$$

In addition to the temperature measured value, the material-specific parameters a, b, c, d read out from the product database were also used to calculate the density. Proceeding from the calculated reference value, to calculate the acceptable range, a fixed value of 0.001 g/cm³ was subtracted from the reference value in order to obtain the minimum value of the acceptable range, and added to the reference value in order to obtain the maximum value of the acceptable range.

For test purposes, a different product was transported through the pipeline to the target container without changing the calculated acceptable range. The data processing device recognized that the density measured value lay outside the acceptable range, and output a signal in the form of a graphic indicator on the display for the operator. At the same time, control signals were transmitted from the data processing device to the control valves, which thereupon closed and shut off the pipeline. The product, the density of which did not match with the acceptable range, was thus enclosed in the pipeline before it reached the target container, and could be disposed of properly.

The reference value calculated by the formula indicated above for the product A originally transported through the pipeline was 0.9201 g/cm³. The acceptable range was calculated with a lower limit of 0.9191 g/cm³ and an upper limit of 0.9211 g/cm³. The product B transported through the pipeline for test purposes had a density of 0.9252 g/cm³. The method according to the invention was capable of reliably distinguishing between the two products in spite of the very minor density difference and recognizing a deviation of the density measured value from the predetermined acceptable range. Product A and product B could be reliably identified and a confusion could thus be precluded.

1.-9. (canceled)

10. A method for monitoring a loading process, in which a liquid is transported from a starting container through a pipeline into a target container, wherein the method is carried out in a data processing device, comprising the following steps:
(a) reading measured values of the density and either the pressure or the temperature or the pressure and the temperature of the liquid transported in the pipeline from at least one measuring device,
(b) determining an acceptable range of the density of the liquid transported in the pipeline by
(b1) reading an acceptable range of the density or
(b2) calculating an acceptable range of the density on the basis of the read measured values of pressure and/or temperature,
(c) comparing the density measured value to the acceptable range, wherein the density measured value and/or the acceptable range are adapted if necessary as a function of the pressure and/or temperature measured values, so that they are comparable, and
(d) outputting a signal if the density measured value is outside the acceptable range.

11. The method according to claim 10, wherein in step (b1), initially an identification feature for the liquid transported through the pipeline is read from an input unit, and then the acceptable range for the density is read out from a product database on the basis of the identification feature.

12. The method according to claim 10, wherein in step (b1), reference values for pressure and temperature assigned to the acceptable range are read, and in step (c), the adaptation of the density measured value and/or the acceptable range takes place on the basis of the pressure and temperature reference values and the pressure and/or temperature measured values.

13. The method according to claim 10, wherein the metrological determination of the density takes place in a flow meter.

14. The method according to claim 10, wherein the output of the signal in step (d) causes an optically and/or acoustically perceptible display for an operator of the loading process.

15. The method according to claim 10, wherein the signal in step (d) comprises a positioning signal, which is output to a shutoff fitting, and the shutoff fitting is prompted by the positioning signal to shut off the pipeline, so that the transport of the liquid is stopped.

16. An apparatus for monitoring a loading process, in which a liquid is transported from a starting container through a pipeline into a target container, comprising a data processing device, which includes:
means for reading measured values of the density and either the pressure or the temperature or the pressure and the temperature of the liquid transported in the pipeline from at least one measuring device,
means for determining an acceptable range of the density of the liquid transported in the pipeline, the means for determining comprising means for reading an acceptable range of the density from an input unit and/or means for calculating an acceptable range of the density on the basis of the pressure and/or temperature measured values,
means for comparing the density measured value to the acceptable range, which are configured so that the density measured value and/or the acceptable range are adaptable as a function of the pressure and/or temperature measured values, and
means for outputting a signal if the density measured value is outside the acceptable range.

17. A computer program having program code which, when the computer program is executed on a suitable computer system, carries out a method according to claim 10.

18. A computer program product having a computer-readable medium and a computer program, stored on the computer-readable medium, having program code means which, when the computer program is run on a suitable computer system, carry out a method according to claim 10.
